(19) United States
(12) Patent Application Publication
(10) Pub. No.: US 2006/0222083 A1
(43) Pub. Date: Oct. 5, 2006

(54) Digital filter with spatial scalability

(76) Inventor: Reinier Bernardus Maria Klein Gunnewiek, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/539,364

(22) PCT Filed: Nov. 18, 2003
(86) PCT No.: PCT/IB03/05298

§ 371 Date: Jun. 15, 2005

(30) Foreign Application Priority Data
Dec. 19, 2002 (EP) 02080372.2

(51) Int. Cl. H04B 1/66

(52) U.S. Cl. 375/240.29

(57) ABSTRACT

A method, filter and a video coder filtering a signal is described. The filter (92) comprises a first set of multipliers (102, 104, 106) filtering samples of the signal with a first phase of filter coefficients (C2, C4, C6), first summing units (108, 110) adding together the first filtered samples for forming a first sum signal, a second set of multipliers (114, 116, 118, 120) filtering the samples with a second phase of filter coefficients (C1, C3, C5, C7), second summing units (122, 124, 126) adding together the second filtered samples for forming a second sum signal and normalizers (112, 128) dividing the first sum signal with the sum of the first phase coefficients and the second sum signal with the sum of the second phase coefficients for providing first and second output signals. This allows optimisation of the coefficients without making the sums of the coefficient sets equal.

### TECHNICAL FIELD

The present invention is directed towards filtering of signals, which at least require some upscaling. The present invention is more particularly directed towards a filtering device and a method of filtering an input signal as well as a video coding device including such a filtering device.

### BACKGROUND OF THE INVENTION

There are many applications in which there is a need to use filters to upscale and downscale input signals in order to vary the resolution of the input signal. One such application is video. Here it might be of interest to scale the resolution of video information in order to be able to use different screen sizes, i.e. to convert the pixel format of the video information to another pixel format to obtain a higher or lower resolution.

In many coding schemes like some video compression standards, e.g. MPEG-2, MPEG-4 and H263, such scaling or spatial scalability is often not used due to lack of coding efficiency. Design of filters for up and down scaling is simple for easy scaling factors like a factor of two. However, these factors are normally not applicable within the field of video applications. There can be instances when one type of screen has 720×480 pixels, while another screen has 1920×1080 pixels. Then there is a scaling need of 480 pixels to 1080 pixels and of 720 pixels to 1920 pixels. The filters for these scaling factors will then be less accurate if the number of filter coefficients in the filter is kept low, which introduces some extra energy in the residue signal. This will in turn lead into less coding efficiency when coding the signal to for instance an MPEG-signal. These coding schemes often need close to ideal low pass filters. In order to keep the complexity and the price of these filters down it is also often a requirement that these filters have a simple design. Ideal low pass filters cannot be implemented for the above described scaling factors used (⅜ and 4/9) with known filter designs while at the same time keeping the design simple. For normal filters either a high precision is required, which leads to a more complex and expensive filter or a simpler filter is used, which leads to a lesser precision because of the non-constant amplification.

U.S. Pat. No 4,665,433 describes compression of images using a filter. The filter has filter coefficients that are dynamically changed based on a comparison factor of the picture. If no or too high a compression is needed the center weight of the filter is set to unity, while the other coefficients are set to zero. If however compression is needed the filter coefficients are set for reducing the resolution. The filter coefficients then have a maximum weight in the middle and with non-zero weights on the sides. The filter characteristic is adaptive, in that the weights can be changed in dependence on a difference signal for reducing resolution progressively. This document is silent concerning odd scaling factors.

The present invention is therefore directed towards providing a filter, which can be simple in construction and still has a close to optimal frequency response for odd scaling factors, for reducing the errors in the filtered signal, while at the same time keeping the filter design simple.

### SUMMARY OF THE INVENTION

The present invention is therefore directed towards solving the problem of providing filtering, which is capable of providing a good response for odd scaling factors without having to increase the number of filter coefficients.

One object of the present invention is therefore to provide a method of filtering an input signal, which method is capable of providing a good response for odd conversion factors without having to increase the number of filter coefficients.

According to a first aspect of the present invention this is accomplished by a method of filtering an input signal where the filter coefficients are divided into more than one phase, and comprising the steps of: performing a first filtering of samples of the input signal with a first phase of filter coefficients, adding together the first filtered samples for forming a first sum signal, performing at least one further filtering of samples of the input signal with a another phase of filter coefficients, adding together the filtered samples of each further phase to form at least one further sum signal, and dividing the first sum signal with the sum of the first phase of filter coefficients and each further sum signal with the sum of the corresponding phase of filter coefficients for outputting the thus normalized sum signals as a first and further output signals from the filter.

Another object of the present invention is to provide a filtering device, which is capable of providing a good response for odd scaling factors without having to increase the number of filter coefficients.

According to a second aspect of the present invention, this is achieved by a filtering device for filtering an input signal comprising: a first set of multiplying units for filtering of samples of the input signal with a first phase of filter coefficients, at least one first summing unit for adding together the first filtered samples for forming a first sum signal, at least one further set of multiplying units for filtering samples of the input signal with at least one further phase of filter coefficients, at least one further summing unit for adding together the further filtered samples for forming at least one further sum signal, and at least one normalizing unit dividing the first sum signal with the sum of the first phase of filter coefficients and each further sum signal with the sum of the corresponding phase of filter coefficients for outputting at least the thus normalized sum signals as a first and further output signals from the filter.

Yet another object of the present invention is to provide a video coding device, which has an increased bit rate efficiency.

According to a third aspect of the present invention, this is achieved by a video coding device including at least one filter for filtering signals, which filter comprises: a first set of multiplying units for filtering of samples of the input signal with a first phase of filter coefficients, at least one first summing unit for adding together the first filtered samples for forming a first sum signal, at least one further set of multiplying units for filtering samples of the input signal with at least one further phase of filter coefficients, at least one further summing unit for adding together the further filtered samples for forming at least one further sum signal, and at least one normalizing unit dividing the first sum signal with the sum of the first phase of filter coefficients and each further sum signal with the sum of the corresponding phase of filter coefficients for outputting at least the thus normalized sum signals as a first and further output signals from the filter.

A video coding device according to the invention is for instance the video-coding device described in EP application no. 02075916.3 filed Aug. 3, 2002 (attorney's docket PHNL020174).

With the present invention the filter coefficients can be selected for optimal filtering without having to provide the sum of the different sets of filter coefficients equal in the process of filtering. Because of this the number of filter coefficients can be kept low without degrading the efficiency of the filter, especially for odd conversion factors. This makes the filter according to the invention simpler and cheaper than a standard filter having the same efficiency and makes the filter according to the invention have a better efficiency than a standard filter having the same amount of filtering coefficients. When used in video applications the present invention provides a better coding efficiency for the coder with a simple filter implementation.

Another advantage of the present invention is that it is easily combined and works well with video coding techniques.

A video coding device is here intended to include both an encoding and a decoding device.

The above mentioned and other aspects of the invention will be apparent from and elucidated with reference to the embodiments described hereinafter.

### BRIEF DESCRIPTION OF THE DRAWINGS

The present invention will be further described in relation to the accompanying drawings, in which:

FIG. 1 shows a block diagram of a video coder including filters according to the invention,

FIG. 2 shows a schematic block diagram of the filter according to the invention connected to a sampling unit and a downscaling unit,

FIG. 3 shows a schematic circuit diagram of a simple filter according to the invention, and

FIG. 4 shows a flow chart for performing the method according to the invention.

### DETAILED DESCRIPTION OF THE INVENTION

When performing filtering of signals it is frequently required to do up or down scaling of input signals. When for instance performing coding of different types of signals, like for instance video compression with for example MPEG-2, MPREG 4 and H263, there can be a need to scale the number of pixels used between different types of resolutions. If the filters used in these devices are not good enough, difficulties will arise in the coding. Examples of conversion factors applicable in these cases are from 720×480 to 1920×1080, which makes the filters either being very complex having a large amount of coefficients, which will make the filter construction more complicated and expensive, or if a more simple filter design is used with lesser coefficients, then some errors which give rise to errors in the signal delivered can be a negative result. One possible application of filters according to the invention will be described. The application is made in an MPEG encoder although other applications are also feasible. It should also be realized that the invention is equally as well applicable in a video decoder. It should furthermore be realized that the invention is applicable to any type of scaling factors. One prerequisite is however that upscaling is performed in the filtering process. The final result might however be a downscaling of the input signal.

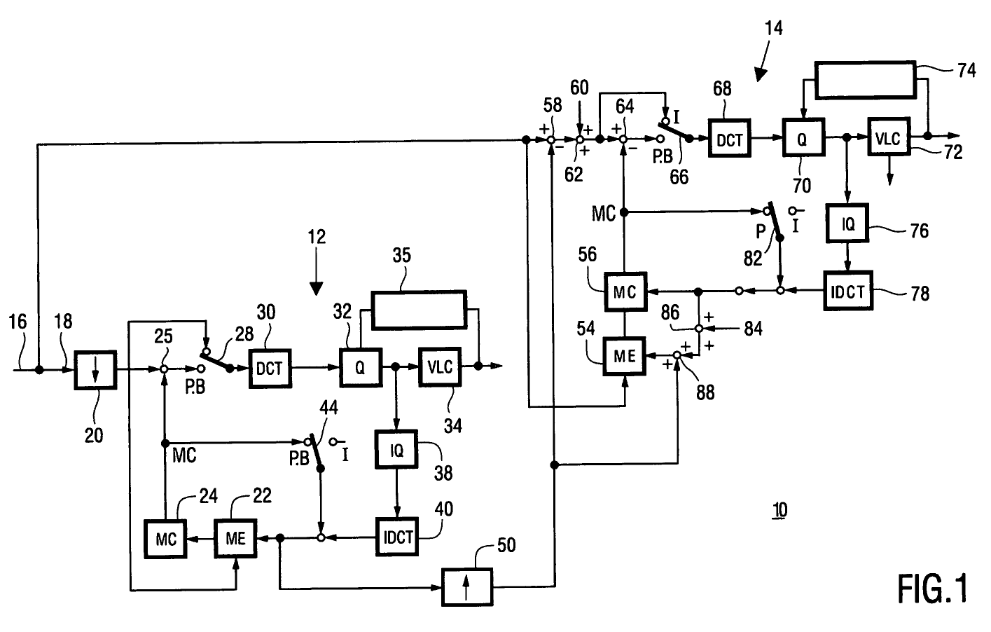

FIG. 1 is a schematic diagram of such a video encoder. The depicted encoding system 10 accomplishes layered compression, whereby a portion of the channel is used for providing a low resolution base layer and the remaining portion is used for transmitting edge enhancement information, whereby the two signals may be recombined to bring the system up to high resolution.

The encoder 10 comprises a base encoder 12 and an enhancement encoder 14. The base encoder comprises a low pass filter and downsampler 20, a motion estimator 22, a motion compensator 24, an orthogonal transform (e.g., Discrete Cosine Transform (DCT)) circuit 30, a quantizer 32, a variable length coder (VLC) 34, a bitrate control circuit 35, an inverse quantizer 38, an inverse transform circuit 40, switches 28, 44, and an interpolate and upsample circuit 50. The downsample and upsample circuits 20 and 50 comprise filters according to the invention. It should also be realised that both the upsampling and downsampling circuits in reality each include two filters: one for scaling in the vertical direction and one for scaling in the horizontal direction in order to provide the different pixel formats.

An input video block 16 is split by a splitter 18 and sent to both the base encoder 12 and the enhancement encoder 14. In the base encoder 12, the input block is inputted into a low pass filter and downsampler 20. The low pass filter reduces the resolution of the video block, which is then fed to the motion estimator 22. The principle of this reduction will be explained later on in this description. The motion estimator 22 processes picture data of each frame as an I-picture, a P-picture, or as a B-picture. Each of the pictures of the sequentially entered frames is processed as one of the I-, P-, or B-pictures in a pre-set manner, such as in the sequence of I, B, P, B, P, . . . , B, P. That is, the motion estimator 22 refers to a pre-set reference frame in a series of pictures stored in a frame memory (not illustrated) and detects the motion vector of a macro-block, that is, a small block of 16 pixels by 16 lines of the frame being encoded by pattern matching (block Matching) between the macro-block and the reference frame for detecting the motion vector of the macro-block.

In MPEG, there are four picture prediction modes, that is an intra-coding (intra-frame coding), a forward predictive coding, a backward predictive coding, and a bi-directional predictive-coding. An I-picture is an intra-coded picture, a P-picture is an intra-coded or forward predictive coded or backward predictive coded picture, and a B-picture is an intra-coded, a forward predictive coded, or a bi-directional predictive-coded picture.

The motion estimator 22 performs forward prediction on a P-picture to detect its motion vector. Additionally, the motion estimator 22 performs forward prediction, backward prediction, and bi-directional prediction for a B-picture to detect the respective motion vectors. In a known manner, the motion estimator 22 searches, in the frame memory, for a block of pixels, which most resembles the current input block of pixels. Various search algorithms are known in the art. They are generally based on evaluating the mean absolute difference (MAD) or the mean square error (MSE) between the pixels of the current input block and those of the candidate block. The candidate block having the least MAD or MSE is then selected to be the motion-compensated prediction block. Its relative location with respect to the location of the current input block is the motion vector.

Upon receiving the prediction mode and the motion vector from the motion estimator 22, the motion compensator 24 may read out encoded and already locally decoded picture data stored in the frame memory in accordance with the prediction mode and the motion vector and may supply the read-out data as a prediction picture to arithmetic unit 25 and switch 44. The arithmetic unit 25 also receives the input block and calculates the difference between the input block and the prediction picture from the motion compensator 24. The difference value is then supplied to the DCT circuit 30.

If only the prediction mode is received from the motion estimator 22, that is, if the prediction mode is the intra-coding mode, the motion compensator 24 may not output a prediction picture. In such a situation, the arithmetic unit 25 may not perform the above-described processing, but instead may directly output the input block to the DCT circuit 30.

The DCT circuit 30 performs DCT processing on the output signal from the arithmetic unit 33 so as to obtain DCT coefficients, which are supplied to a quantizer 32. The quantizer 32 sets a quantization step (quantization scale) in accordance with the data storage quantity in a buffer (not illustrated) received as a feedback and quantizes the DCT coefficients from the DCT circuit 30 using the quantization step. The quantized DCT coefficients are supplied to the VLC unit 34 along with the set quantization step.

The VLC unit 34 converts the quantization coefficients supplied from the quantizer 32 into a variable length code, such as a Huffman code, in accordance wth the quantization step supplied from the quantizer 32. The resulting converted quantization coefficients are outputted to a buffer (not illustrated). The quantization coefficients and the quantization step are also supplied to an inverse quantizer 38, which dequantizes the quantization coefficients in accordance with the quantization step so as to convert the same to DCT coefficients. The DCT coefficients are supplied to the inverse DCT unit 40 which performs inverse DCT on the DCT coefficients. The obtained inverse DCT coefficients are then supplied to the arithmetic unit 48.

The arithmetic unit 48 receives the inverse DCT coefficients from the inverse DCT unit 40 and the data from the motion compensator 24 depending on the location of switch 44. The arithmetic unit 48 sums the signal (prediction residuals) from the inverse DCT unit 40 to the predicted picture from the motion compensator 24 to locally decode the original picture. However, if the prediction mode indicates intra-coding, the output of the inverse DCT unit 40 may be directly fed to the frame memory. The decoded picture obtained by the arithmetic unit 40 is sent to and stored in the frame memory so as to be used later as a reference picture for an inter-coded picture, forward predictive coded picture, backward predictive coded picture, or a bi-directional predictive coded picture.

The enhancement encoder 14 comprises a motion estimator 54, a motion compensator 56, a DCT circuit 68, a quantizer 70, a VLC unit 72, a bitrate controller 74, an inverse quantizer 76, an inverse DCT circuit 78, switches 66 and 82, subtractors 58 and 64, and adders 80 and 88. In addition, the enhancement encoder 14 may also include DC-offsets 60 and 84, adder 62 and subtractor 86. The operation of many of these components is similar to the operation of similar components in the base encoder 12 and will not be described in detail.

The output of the arithmetic unit 40 is also supplied to the upsampler 50 which generally reconstructs the filtered out resolution from the decoded video stream and provides a video data stream having substantially the same resolution as the high-resolution input. How this upsampling can be performed will be described later on in this description. However, because of the filtering and losses resulting from the compression and decompression, certain errors are present in the reconstructed stream. These errors are smaller than would normally be the case for a smaller prior art filter because of the present invention, which will be described later on. The errors are determined in the subtraction unit 58 by subtracting the reconstructed high-resolution stream from the original, unmodified high-resolution stream.

The original unmodified high-resolution stream is also provided to the motion estimator 54. The reconstructed high-resolution stream is also provided to an adder 88 which adds the output from the inverse DCT 78 (possibly modified by the output of the motion compensator 56 depending on the position of the switch 82). The output of the adder 88 is supplied to the motion estimator 54. As a result, the motion estimation is performed on the upscaled base layer plus the enhancement layer instead of the residual difference between the original high-resolution stream and the reconstructed high-resolution stream.

Furthermore, a DC-offset operation followed by a clipping operation can be introduced into the enhancement encoder 14, wherein the DC-offset value 60 is added by adder 62 to the residual signal output from the subtraction unit 58. This optional DC-offset and clipping operation allows the use of existing standards, e.g., MPEG, for the enhancement encoder where the pixel values are in a predetermined range, e.g., 0 . . . 255. The residual signal is normally concentrated around zero. By adding a DC-offset value 60, the concentration of samples can be shifted to the middle of the range, e.g., 128 for 8 bit video samples. The advantage of this addition is that the standard components of the encoder for the enhancement layer can be used and result in a cost efficient (re-use of IP blocks) solution.

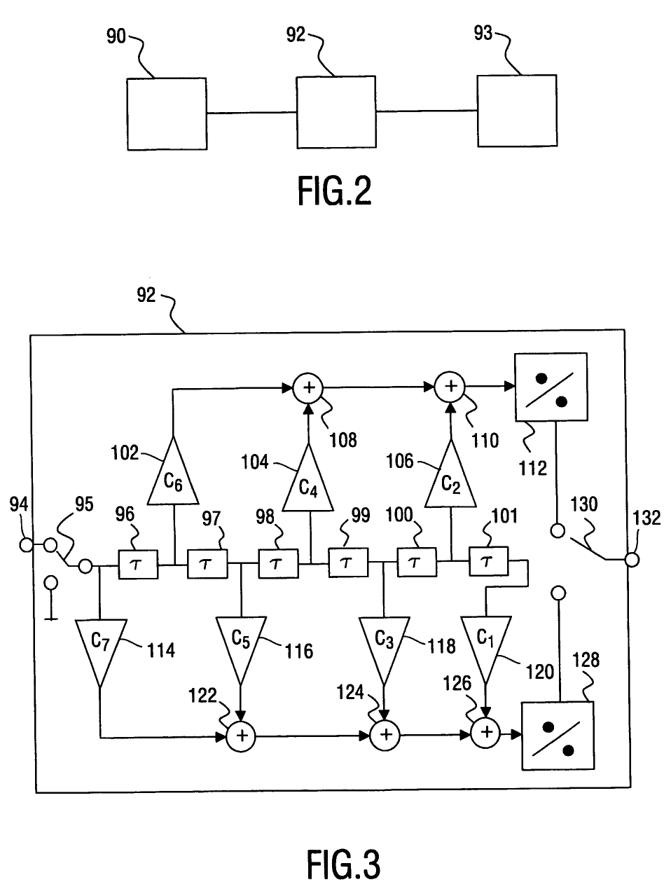

FIG. 2 shows a schematic block diagram of an upsampling or downsampling circuit of FIG. 1. First there is a sampling unit 90 sampling the input signal, which is connected to the filter 92 according to the invention. The filter is finally connected to a reduction unit 93. When upscaling a signal for example by ⅜, a number of samples of the input signal are taken in the sampling unit 90. The filter 92 then filters these samples and produces a number of output signals per sample, which in this example is eight. For each sample input to the filter 92, the filter then generates eight output signals. These output signals are then sent to the reduction unit 93, which in turn keeps every third of these output signals. If a first output signal from the filter is selected to be retained, then the reduction unit 93 deletes the following two output signals and retains the following fourth signal. This scheme is of course not limited to ⅜, but a similar scheme can be applied for 4/9 or really any other conversion scheme that is used. The sampler and the reduction unit are furthermore shown as being separate entities from the filter, they can however also be part of the filter either both or just one of them. Downscaling is performed in a similar way. When downscaling by ⅜, the filter would then produce 3 output signals per sample and the reduction unit would retain every eight output signal.

Now the filter according to the invention will be described in relation to FIG. 3, which shows a circuit diagram of a simple low pass filter, which is close to being an ideal low pass filter. The filter is suitable for upscaling by a factor of two. The reason that this filter is chosen for explaining the invention is that for this type of filter the filter coefficients are kept fairly low and simple and therefore the invention is easier to explain. It should however be realized that the invention is applicable for several types of filters having many more filter coefficients.

FIG. 3 shows a filter or filtering device 92 according to the invention. The filter 92 includes one input 94 connected to the previously mentioned sampling unit. A first terminal of a first switch 95 is connected to the input 94. A second terminal of the switch 95 is connected to a ground or zero potential, while a third terminal of the first switch 95 is connected to the input of a first delay unit 96. The output of the first delay unit 96 is connected to the input of a second delay unit 97. The output of the second delay unit 97 is connected to the input of a third delay unit 98. The input of a fourth delay unit 99 is connected to the output of the third delay unit 98. The input of a fifth delay unit 100 is connected to the output of the fourth delay unit 99. The input of a sixth delay unit 101 is connected to the output of the fifth delay unit 100. An input of a first multiplying unit 102 having a filter coefficient C₆ is connected to the output of the first delay unit 96 and the output of the first multiplying unit 102 is connected to a first adding unit 108. The input of a second multiplying unit 104 having a filter coefficient C₄ is connected to the output of the third delay unit 98. The output of the second multiplying unit 104 is also connected to the first adding unit 108. The first adding unit 108 is also connected to a second adding unit 110. The input of a third multiplying unit 106 having a filter coefficient C₂ is connected to the output of the fifth delay unit 100. The output of the third multiplying unit 106 is connected to the second adding unit 110. The second adding unit 110 is connected to the input of a first normalizing unit 112. The input of a fourth multiplying unit 114 having a filter coefficient C₇ is connected to the third terminal of the first switch 95. The output of the fourth multiplying unit 114 is connected to a third adding unit 122. The input of a fifth multiplying unit 116 having a filter coefficient C₅ is connected to the output of the second delay unit 97. The output of the fifth multiplying unit 116 is connected to the third adding unit 122. The third adding unit 122 is also connected to a fourth adding unit 124. The input of a sixth multiplying unit 118 having a filter coefficient C₃ is connected to the output of the fourth delay unit 99. The output of the sixth multiplying unit 118 is connected to the fourth adding unit 124. The fourth adding unit 124 is also connected to a fifth adding unit 126. The input of a seventh multiplying unit 120 having a filter coefficient C₁ is connected to the output of the sixth delay unit 101. The output of the seventh multiplying unit 120 is connected to the fifth adding unit 126. The fifth adding unit 126 is connected to an input of a second normalizing unit 128. The output of the first normalizing unit 112 is connected to a first terminal of a second switch 130. The output of the second normalizing unit 128 is connected to a second terminal of the second switch 130. A third terminal of the second switch 130 is connected to the output 132 of the filter. The filter includes a first set of multiplying units comprising the first, second and third multiplying units 102, 104 and 106, which provides a first phase or set of filter coefficients. The filter also includes a second set of multiplying units comprising the fourth, fifth, sixth and seventh multiplying units 114, 116, 118 and 120, which set provides a second phase or set of filter coefficients.

The functioning of the filter will now be described in more detail. A number of samples of an input signal are taken by the sampling unit from FIG. 2 and provided to the input 94 of the filter. The samples are provided to the different multiplying units via the delay units by clocking by a suitable clock (not shown). Between each sample one zero sample is inserted by the first switch 95 being connected to ground. At a certain point in time a first sample is provided from the fifth delay unit 100, a second sample from the third delay unit 98 and a third sample from the first delay unit 96. The first sample is multiplied with the filter coefficient C₂ in the third multiplying unit 106, the second sample is multiplied with the filter coefficient C₄ in the second multiplying unit 104 and the third sample is multiplied with the filter coefficient C₆ in the first multiplying unit 102. The samples at the output of the sixth delay unit 101, the fourth delay unit 99, the second delay unit 97 and at the third terminal of the first switch 95 are all zero in this case because of the zero samples inserted by the first switch 95. The multiplied third sample and the multiplied second sample are then added to each other in the first adding unit 108 and this sum is added to the first multiplied sample in the second adding unit 110. Thereby a first sum signal is obtained. The first normalizing unit 112 normalizes the first sum signal by dividing it with the sum of the filter coefficients in the first set, i.e. the coefficients C₂, C₄ and C₆. Thereby a first output signal is generated, which is delivered on the output 132 of the filter 92 by the second switch 130. Upon clocking of the filter, the first sample is then provided from the sixth delay unit 101, the second sample from the fourth delay unit 99, the third sample from the second delay unit 97 and a fourth sample directly from the third terminal of the first switch 95. Now the samples at the outputs of the fifth, third and first delay units 100, 98 and 96 are all zero because of the zero samples inserted by the first switch 95. The first sample is then multiplied with the filter coefficient C₁ in the seventh multiplying unit 120, the second sample is multiplied with the filter coefficient C₃ in the sixth multiplying unit 118, the third sample is multiplied with the filter coefficient C₅ in the fifth multiplying unit 116 and the fourth sample is multiplied with the filter coefficient C₇ in the fourth multiplying unit 114. These multiplied samples are added together to form a second sum signal by the adding units 122, 124 and 126 in the same manner as the first sum signal was generated. The second normalizing unit 128, which has received the second sum signal from the fifth adding unit 126, normalizes it by dividing it with the sum of the filter coefficients in the second set, i.e. the coefficients C₁, C₃, C₅ and C₇. Thereby a second output signal is generated, which is delivered on the output 132 of the filter 92 by the second switch 130. In this way it is ensured that the output signals have equal gain. The second, third and fourth samples are multiplied by the first, second and third multiplying units 102, 104, 106 during the next clock cycle for producing further sum signals to be used in the first normalizing unit and in this way sums signals are continuously being generated based on the input signal samples. In this way the filter continues to provide two output signals for each new sample of the input signal input to the filter. Thus an up scaling with a factor of two is obtained, which can be followed by downscaling in the previously described reduction unit.

Previously normalization has been performed through division of the sum signals with all filter coefficients. In that case care had to be taken when selecting filter coefficients so that the sum signals provided would be equal in size. With the filtering according to the present invention, this is not necessary. The filter coefficients can be dimensioned for optimal filtering without regard being taken for providing equal sized sum signals. This type of filtering then produces a result, which has less errors for an input signal than the previously known filters.

It should be realized that the invention could be provided with only two adding units for the adding together the two sum signals. It is also possible that there is only one normalizing unit instead of two. Then the second switch would be provided before this sole normalizing unit and it would change denominator between the two sum signals. It is furthermore possible to perform the different additions by use of software instead of different discrete circuits or units.

An example on a typical selection of filter coefficients for the above-described filter will now be given in table 1 below. As a comparison the coefficients for a standard prior art filter is also given.

TABLE 1

| FILTER COEFFICIENTS | NEW FILTER | PRIOR ART FILTER |
|---|---|---|
| C₁ | −2 | −3 |
| C₂ | 0 | 0 |
| C₃ | 19 | 19 |
| C₄ | 32 | 32 |
| C₅ | 19 | 19 |
| C₆ | 0 | 0 |
| C₇ | −2 | −3 |

As can be seen from table 1, the second sum signal C₁+C₃+C₅+C₇=32 and the first sum signal C₂+C₄+C₆=32 for the prior art filter, whereas these sums are equal to 34 and 32, respectively, for the filter according to the invention. The filter coefficient C₄ in the first set is a center coefficient.

The described filter was a simplified filter providing two output signals. The present invention is also applicable on filters capable of providing more output signals. Below is found one example that can be used for providing three output signals from one output signal.
C₁=0, C₂=8.9, C₃=17.7, C₄=0, C₅=−60.88, C₆=−102.5, C₇=0, C₈=295.2, C₉=643.2, C₃₀=800, C₁₁=643.2, C₁₂=295.2, C₁₃=0, C₁₄=−102.5, C₁₅=−60.88, C₁₆=0, C₁₇=17.7, C₁₈=8.9 and C₁₉=0.

In order to provide such a filter that up scales to three output signals, there are three phases or sets of filter coefficients where C₁, C₄, C₇, C₃₀, C₁₃, C₁₆ and C₁₉ make up a first phase, C₂, C₅, C₈, C₁₁, C₁₄ and C₁₇ make up a second phase and C₃, C₆, C₉, C₁₂, C₁₅ and C₁₇ make up a third phase. In order to provide this type of filter based on the filter in FIG. 3, more delay units have to be provided, there is also a third normalizing unit to which a sum of samples multiplied by the third set are provided. Two zero samples would furthermore be inserted between each “real” sample. The switch would also have to have three different positions to switch between.

It should also be realized that the invention could be varied in that the filter or the sampling unit does not insert zero samples between each sample of the input signal. Such a filter can be realized using six delay units, four multiplying units and three adding units.

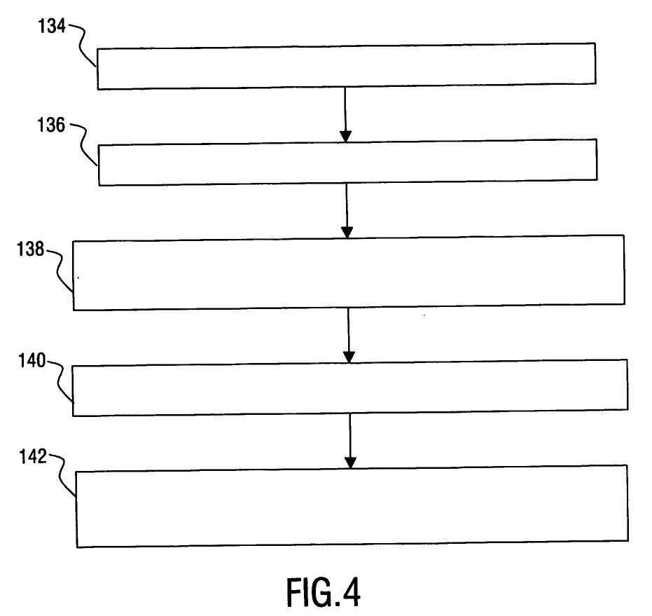

For completeness a method of filtering according to the invention will now be described with reference to FIG. 4, which shows a flow chart of the method. First the input signal is sampled, step 134. For every set of filter coefficients existing in the filter, step 136, the following steps are then performed: Samples of the input signal are filtered with the set of filter coefficients, step 138. The filtered samples, which have thus been multiplied with filter coefficients, are then added together to form a sum signal, step 140. The sum signal is then divided with the sum of filter coefficients in the set and provided as one output signal, step 142. Steps 138-142 are thus performed once for all sets of filter coefficients, i.e. if there are two sets, they are performed twice, if there are three sets they are performed three times etc., so that up scaling with the wanted factor is obtained. This up scaling can of course also be combined with the previously described downscaling.

With the present invention a filter is obtained that gives close to optimal filtering when odd up and down conversion scales are applied without having to increase the number of filter coefficients in the filter. In this way the filter coefficients of the filter can be kept low, while still keeping the errors in the output of the filter low. This reduces the energy in the residue signal when coding in for instance an MPEG-coder. This also gives the coder a better coding efficiency. Experiments have shown that a bit rate gain of 3 to five percent can be obtained in the previously described base layer as well as for the also previously described enhancement layer, when a filter designed according to then invention has been used. Furthermore, the perceived picture quality is somewhat better than when ordinary filters with the same amount of filter coefficients are used.

Many of the advantages described have been made in relation to video coding. In relation to this it is applicable to the field of DVD. It should however be realized that the present invention is not limited to video coding. It is applicable on any type of up and down scaling, like for instance also coding of sound. It can equally possibly be used for layered or elastic storing of programs on a disc.

1. Method of filtering an input signal where the filter coefficients are divided into more than one phase, and comprising the steps of:
performing a first filtering of samples of the input signal with a first phase of filter coefficients, (step 138),
adding together the first filtered samples for forming a first sum signal, (step 140),
performing at least one further filtering of samples of the input signal with a another phase of filter coefficients, (step 138),
adding together the filtered samples of each further phase to form at least one further sum signal, (step 140), and
dividing the first sum signal with the sum of the first phase of filter coefficients and each further sum signal with the sum of the corresponding phase of filter coefficients for outputting the thus normalized sum signals as a first and further output signals from the filter, (step 142).

2. Method according to claim 1, wherein the sum of the at least one further phase of filter coefficients can be different than the sum of the other phase of filter coefficients.

3. Method according to claim 1, further including the step of reducing the output signals by retaining every nth output signal and deleting the output signals in-between two retained signals, where n is an integer corresponding to a downscaling factor.

4. Method according to claim 1, wherein the filtering performed is a low pass filtering.

5. Method according to claim 1, wherein the frequency response of the filter is close to optimal.

6. Method according to claim 1, further including the step of inserting at least one zero sample between each sample of the input signal.

7. Method according to claim 1, further including the step of sampling the input signal for providing a number of samples.

8. Filtering device for filtering an input signal and comprising:
a first set of multiplying units for filtering of samples of the input signal with a first phase of filter coefficients,
at least one first summing unit for adding together the first filtered samples for forming a first sum signal,
at least one further set of multiplying units for filtering samples of the input signal with at least one further phase of filter coefficients,
at least one further summing unit for adding together the further filtered samples for forming at least one further sum signal, and
at least one normalizing unit dividing the first sum signal with the sum of the first phase of filter coefficients and each further sum signal with the sum of the corresponding phase of filter coefficients for outputting at least the thus normalized sum signals as a first and further output signals from the filter.

9. Filtering device according to claim 8, wherein the sum of the at least one further phase of filter coefficients can be different than the sum of the other phase of filter coefficients.

10. Filtering device according to claim 8, in which there is one normalizing unit provided for each sum signal.

11. Filtering device according to claim 8, further including a reduction unit arranged to reduce the output signals by retaining every nth output signal and deleting the output signals in-between two retained signals, where n is an integer corresponding to a downscaling factor.

12. Filtering device according to claim 8, wherein the filtering device is a low pass filter.

13. Video coding device including at least one filter for filtering signals, which filter comprises:
a first set of multiplying units for filtering of samples of the input signal with a first phase of filter coefficients,
at least one first summing unit for adding together the first filtered samples for forming a first sum signal,
at least one further set of multiplying units for filtering samples of the input signal with at least one further phase of filter coefficients,
at least one further summing unit for adding together the further filtered samples for forming at least one further sum signal, and
at least one normalizing unit dividing the first sum signal with the sum of the first phase of filter coefficients and each further sum signal with the sum of the corresponding phase of filter coefficients for outputting at least the thus normalized sum signals as a first and further output signals from the filter.

14. Video coding device according to claim 13, including a first and second filter, where the first filter is a downsampling filter and the second filter is an upsampling filter and further including a subtracting unit for calculating a difference signal between an input signal and a down- and upsampled version of the input signal.
